(19) United States
(12) Patent Application Publication
(10) Pub. No.: US 2022/0380234 A1
(43) Pub. Date: Dec. 1, 2022

(54) ELECTROCATALYTIC DEGRADATION DEVICE FOR ORGANIC WASTEWATER

(71) Applicant: Shandong Ruike Environmental Technology Co., Ltd., Zibo (CN)

(72) Inventors: Shichen MU, Zibo (CN); Junxi MU, Zibo (CN)

(21) Appl. No.: 17/827,544

(22) Filed: May 27, 2022

(30) Foreign Application Priority Data
May 31, 2021 (CN) 2021106035095

(51) Int. Cl. C02F 1/467

(52) U.S. Cl. CPC C02F 1/4674; C02F 2101/30

(57) ABSTRACT

Disclosed is an electrocatalytic degradation device for organic wastewater, which includes an electrocatalytic oxidation reactor, a spray tower and a drying tower. The electrocatalytic oxidation reactor is provided with a hydroxyl generator, a catalyst filler and a box body. The box body of the electrocatalytic oxidation reactor is provided with a gas gathering device connected with the spray tower. An upper gas outlet of the spray tower is connected with the drying tower. The disclosure combines the electrooxidation reaction with the catalytic reaction to improve the electrooxidation efficiency of the electrocatalytic oxidation reactor and efficiently degrade the high salt high organic wastewater. The decomposed by-products are effectively utilized. The generated hydrogen is collected by the gas gathering device and enters the spray tower. The CO₂ gas is absorbed after treatment. The CO₂-removed gas passes through the drying tower to absorb moisture to obtain pure hydrogen.

### CROSS REFERENCE TO RELATED APPLICATION

This patent application claims the benefit and priority of Chinese Patent Application No. 202110603509.5 filed on May 31, 2021, the disclosure of which is incorporated by reference herein in its entirety as part of the present application.

### TECHNICAL FIELD

The present disclosure relates to the technical field of wastewater treatment, and more specifically, to an electrocatalytic degradation device for organic wastewater.

### BACKGROUND ART

Industrial wastewater contains not only high concentration of salts, but also high concentration of organic matter. Chemical oxygen demand (COD) is often used as an index to measure the content of organic matter in water. The COD refers to the amount of oxidant consumed when a certain strong oxidant is used to treat a water sample under certain conditions. It is an indicator of the amount of reducing substances in the water.

Electrocatalytic oxidation technology uses electrochemical methods to continuously produce hydroxyl radicals with high activity, so that organic matter can be degraded and mineralized. Its reaction conditions are mild, the process is easy to control, and there is no secondary pollution. It has incomparable advantages over other water treatment technologies. In the traditional electrocatalytic oxidation reaction device, the anode plate does not use a catalyst or the effect of the catalyst is poor, resulting in a low hydroxyl generation rate. The carrier area of the catalyst filler used is small, and the catalysts in the carrier filler are different, or there is no catalyst, which has the disadvantages of low hydroxyl generation rate, small interaction area between hydroxyl and organic matter, poor reaction effect and low hydroxyl utilization rate, resulting in low efficiency of COD degradation and high energy consumption. And the generated hydrogen is not effectively recycled.

Therefore, how to provide an electrocatalytic degradation device for organic wastewater is an urgent problem for those skilled in the art.

### SUMMARY

The disclosure provides an electrocatalytic degradation device for organic wastewater, which aims to solve the above technical problems in the prior art to a certain extent.

In order to achieve the above purpose, the disclosure adopts the following technical scheme.

An electrocatalytic degradation device for organic wastewater includes an electrocatalytic oxidation reactor, a spray tower and a drying tower. The electrocatalytic oxidation reactor includes a box body, a water inlet pipe at a lower end of the box body, a water outlet pipe at an upper end of the box body, a hydroxyl generator and a catalyst filler. The catalyst filler is arranged in the hydroxyl generator. The electrocatalytic oxidation reactor is provided with a gas gathering device. The gas gathering device is connected with the spray tower. And an upper gas outlet of the spray tower is connected with the drying tower.

According to the above technical scheme, compared with the prior art, the disclosure combines the electrooxidation reaction with the catalytic reaction to improve the electrooxidation efficiency of the electrocatalytic oxidation reactor and efficiently degrade the high salt high organic wastewater. And the decomposed by-products are effectively utilized. The generated hydrogen is collected by the gas gathering device and enters the spray tower, and the CO₂ gas is absorbed after treatment. The CO₂-removed gas passes through the drying tower to absorb moisture to obtain pure hydrogen.

Further, upper and lower ends in the box body are respectively provided with a water distributor connected with the water inlet pipe and the water outlet pipe, which solves the problem of unqualified effluent caused by uneven water distribution in the previous electrocatalytic oxidation reactor.

Further, the hydroxyl generator is composed of multiple sets of electrode plates. The multiple sets of electrode plates are evenly distributed in an interior of the box body. Each set of the electrode plates includes an anode plate and a cathode plate arranged oppositely. The anode plate is connected with a positive pole of an DC power supply, and the cathode plate is connected with a negative pole of the DC power supply. A noble metal catalyst is arranged on a surface of the anode plate. The noble metal catalyst is determined according to different water quality, and the noble metals such as ruthenium, iridium and platinum are used. The catalyst filler is filled between the cathode plate and the anode plate, the catalyst filler is loose porous structure particles, and a catalyst is loaded therein. The synergy of the dual catalysts is used to improve the electrooxidation efficiency of the electrocatalytic oxidation reactor, so that the high salt high organic wastewater is degraded and the wastewater treatment efficiency is improved.

Further, the multiple sets of electrode plates are connected in parallel, and a distance between the cathode plate and the anode plate is equal, which is 20-50 mm. And the distance between the cathode plate and the anode plate depends on different water quality.

Further, the catalyst uses manganese dioxide, ferromanganese and alumina, which depends on different water quality.

Further, a discharge valve is provided at a bottom of the box body. It is convenient to discharge when the valve is opened to replace the catalyst filler, or it is used to empty the wastewater in the box body of the reactor.

Further, the electrocatalytic degradation device includes an organic wastewater tank connected with the electrocatalytic oxidation reactor. The high salt high organic wastewater tank inputs the high salt high organic wastewater into the electrocatalytic oxidation reactor through a wastewater pump box.

Further, the spray tower includes a tower body and a circulating tank. The circulating tank is arranged at a bottom of the tower body. The circulating tank is provided with a CO₂ absorption solution. A top of the tower body is provided with a gas outlet, and a lower part of the tower body is provided with a gas inlet. The gas inlet is connected with the gas gathering device. A spray pipe is arranged in the tower body and the spray pipe is provided with an atomizing nozzle. The spray pipe is connected with the circulating tank through a circulating pipe, and a circulating pump is arranged on the circulating pipe.

Further, the gas outlet is connected with the drying tower through pipelines.

Further, the CO₂ absorption solution in the spray tower is a calcium hydroxide solution, and a desiccant in the drying tower is a quicklime.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is a structural diagram of the disclosure.

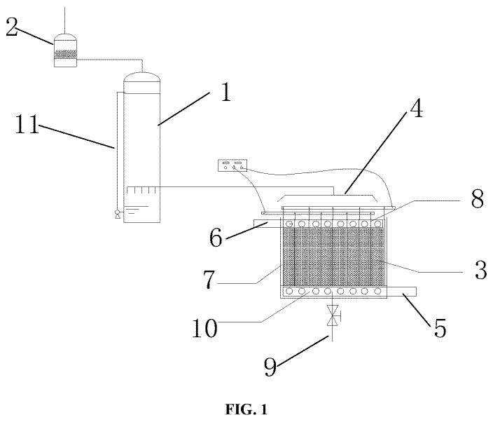

Of which:

1—spray tower; 2—drying tower; 3—catalyst filler, 4—gas gathering device; 5—water inlet pipe; 6—water outlet pipe; 7—anode plate; 8—cathode plate; 9—discharge valve; 10—water distributor; 11—circulating pipe.

### DETAILED DESCRIPTION OF THE EMBODIMENTS

Technical solutions of the present disclosure will be clearly and completely described below with reference to the embodiments. Obviously, the described embodiments are only part of the embodiments of the present disclosure, not all of them. Other embodiments made by those skilled in the art without sparing any creative effort should fall within the scope of the disclosure.

In the description of the disclosure, it should be noted that the orientation or positional relationship indicated by the terms “up”, “down”, “front”, “back”, “left”, “right”, “vertical”, “horizontal”, “top”, “bottom”, “inside”, “outside” and so on is based on the orientation or positional relationship shown in the attached drawings, only for the convenience of describing the disclosure and simplifying the description, rather than indicating or implying that the device or element must have a specific orientation, be constructed and operated in a specific orientation. Therefore, it cannot be understood as a limitation of the present disclosure.

In the present disclosure, unless otherwise expressly specified and limited, the terms “installation”, “connection”, “connecting” and “fixed” should be understood in a broad sense. For example, it can be fixed connection, removable connection, or integrated. It can be mechanical connection or electrical connection. It can be connected directly or indirectly through intermediate media. It can be the connection between two elements or the interaction between two elements. For those skilled in the art, the specific meaning of the above terms in the disclosure can be understood according to the specific situation.

In the present disclosure, unless otherwise expressly specified and limited, the first feature “above” or “below” of the second feature may include direct contact between the first and second features, or the first and second features may not be in direct contact, but through another feature contact between them. Moreover, the first feature is “above”, “up” and “over” of the second feature, including that the first feature is directly above and obliquely above the second feature, or only indicates that the horizontal height of the first feature is higher than the second feature. The first feature is “below”, “down” and “under” of the second feature, including that the first feature is directly below and obliquely below the second feature, or only indicates that the horizontal height of the first feature is less than that of the second feature.

The embodiment of the disclosure discloses an electrocatalytic degradation device for organic wastewater, which includes an electrocatalytic oxidation reactor, a spray tower 1 and a drying tower 2. The electrocatalytic oxidation reactor includes a box body, a water inlet pipe 5 at a lower end of the box body, a water outlet pipe 6 at an upper end of the box body, a hydroxyl generator and a catalyst filler 3. The catalyst filler 3 is arranged in the hydroxyl generator. The electrocatalytic oxidation reactor is provided with a gas gathering device 4. The gas gathering device 4 is connected with the spray tower 1. And an upper gas outlet of the spray tower 1 is connected with the drying tower 2.

The electrocatalytic degradation device further includes a high salt high organic wastewater tank connected with the electrocatalytic oxidation reactor. The high salt high organic wastewater tank inputs the high salt high organic wastewater into the electrocatalytic oxidation reactor through a wastewater pump box.

Specifically, the hydroxyl generator is composed of multiple sets of electrode plates. The multiple sets of electrode plates are evenly distributed in an interior of the box body. Each set of the electrode plates includes an anode plate 7 and a cathode plate 8 arranged oppositely. The anode plate 7 is connected with a positive pole of an DC power supply, and the cathode plate 8 is connected with a negative pole of the DC power supply. A noble metal catalyst is arranged on a surface of the anode plate 7, which adopts noble metals such as ruthenium, iridium and platinum depending on different water quality. The catalyst filler 3 is filled between the cathode plate 8 and the anode plate 7. The catalyst filler 3 is loose porous structure particles with catalysts internal, and the catalyst is manganese dioxide, iron manganese and alumina.

In order to further optimize the above technical scheme, the multiple sets of electrode plates are connected in parallel, and a distance between the cathode plate and the anode plate is equal, which is generally controlled at 20-50 mm. The catalytic oxidation reaction takes place at the interface between wastewater and the anode plate, and the hydroxyl generated cooperates with the catalyst in the filler carrier to act on the organic matter for continuous oxidation and decomposition. Finally, the organic matter is oxidized and decomposed into carbon dioxide and water by hydroxyl, and the wastewater can be effectively degraded and treated.

In order to further optimize the above technical scheme, upper and lower ends in the box body are respectively provided with a water distributor 10 connected with the water inlet pipe 5 and the water outlet pipe 6, which can evenly fill the wastewater in the whole box body of the reactor for high-efficiency electrocatalytic reaction.

In order to further optimize the above technical scheme, a discharge valve 9 is provided at a bottom of the box body to discharge the liquid after reaction from the box body of the reactor.

Specifically, the spray tower 1 includes a tower body and a circulating tank. A top of the tower body is provided with a gas outlet, and the gas outlet is connected with the drying tower 2 through pipelines. A lower part of the tower body is provided with an air inlet connected with the gas gathering device. The circulating tank is arranged at a bottom of the tower body, and the main component is lime water. A spray pipe is arranged in the tower body. The spray pipe is provided with an atomizing nozzle. The spray pipe is connected with the circulating tank through a circulating pipe 11, and a circulating pump is arranged on the circulating pipe 11. The hydrogen generated by electrocatalysis is collected by the gas gathering device and enters the spray tower. CO₂ gas is absorbed by lime water after spray treatment. The CO₂-removed gas passes through the drying tower to absorb moisture to obtain pure hydrogen. Quicklime is selected as a desiccant in drying tower 2.

Various embodiments in the present specification are described in a progressive manner, and the emphasizing description of each embodiment is different from the other embodiments. The same and similar parts of various embodiments can be referred to for each other. For the apparatus disclosed in the embodiments, since the apparatus corresponds to the method disclosed in the embodiments, the description is simplified, and reference may be made to the method part for description.

The above description of the disclosed embodiments enables those skilled in the art to realize or use the present disclosure. Many modifications to these embodiments will be apparent to those skilled in the art. The general principle defined herein can be realized in other embodiments without departing from the spirit or scope of the present invention. Therefore, the present disclosure will not be limited to these embodiments shown herein, but will conform to the widest scope consistent with the principle and novel features disclosed herein.

What is claimed is:

1. An electrocatalytic degradation device for organic wastewater, comprising an electrocatalytic oxidation reactor, a spray tower (1) and a drying tower (2), wherein the electrocatalytic oxidation reactor comprises a box body, a water inlet pipe (5) at a lower end of the box body, a water outlet pipe (6) at an upper end of the box body, a hydroxyl generator and a catalyst filler (3), the catalyst filler (3) is arranged in the hydroxyl generator, the electrocatalytic oxidation reactor is provided with a gas gathering device (4), the gas gathering device (4) is connected with the spray tower (1), and an upper gas outlet of the spray tower (1) is connected with the drying tower (2).

2. The electrocatalytic degradation device for organic wastewater of claim 1, wherein upper and lower ends in the box body are respectively provided with a water distributor (10) connected with the water inlet pipe (5) and the water outlet pipe (6).

3. The electrocatalytic degradation device for organic wastewater of claim 1, wherein the hydroxyl generator is composed of a plurality of sets of electrode plates, the plurality of sets of electrode plates are evenly distributed in an interior of the box body, each set of the electrode plates includes an anode plate (7) and a cathode plate (8) arranged oppositely, the anode plate (7) is connected with a positive pole of an DC power supply, and the cathode plate (8) is connected with a negative pole of the DC power supply; a noble metal catalyst is arranged on a surface of the anode plate (7), the catalyst filler (3) is filled between the cathode plate (8) and the anode plate (7), the catalyst filler (3) is loose porous structure particles, and a catalyst is loaded therein.

4. The electrocatalytic degradation device for organic wastewater of claim 3, wherein the plurality of sets of electrode plates are connected in parallel, and a distance between the cathode plate and the anode plate is equal, 20-50 mm.

5. The electrocatalytic degradation device for organic wastewater of claim 3, wherein the catalyst uses manganese dioxide, ferromanganese and alumina.

6. The electrocatalytic degradation device for organic wastewater of claim 1, wherein a discharge valve (9) is provided at a bottom of the box body.

7. The electrocatalytic degradation device for organic wastewater of claim 1, wherein the spray tower (1) comprises a tower body and a circulating tank, the circulating tank is arranged at a bottom of the tower body, the circulating tank is provided with a CO₂ absorption solution, a top of the tower body is provided with a gas outlet, a lower part of the tower body is provided with a gas inlet, the gas inlet is connected with the gas gathering device (4), a spray pipe is arranged in the tower body, the spray pipe is provided with an atomizing nozzle, the spray pipe is connected with the circulating tank through a circulating pipe (11), and a circulating pump is arranged on the circulating pipe (11).

8. The electrocatalytic degradation device for organic wastewater of claim 1, wherein the gas outlet is connected with the drying tower (2) through pipelines.

9. The electrocatalytic degradation device for organic wastewater of claim 1, wherein the CO₂ absorption solution in the spray tower (1) is a calcium hydroxide solution, and a desiccant in the drying tower (2) is a quicklime.
